(19) United States
(12) Patent Application Publication
(10) Pub. No.: US 2004/0213088 A1
(43) Pub. Date: Oct. 28, 2004

(54) Ultraviolet illumination of indicia, watches and other instruments

(76) Inventor: Michelle J. Fuwausa, Columbia, MD (US)

Correspondence Address: GOTTLIEB RACKMAN & REISMAN PC, 270 MADISON AVENUE, 8TH FLOOR, NEW YORK, NY, 100160601

(21) Appl. No.: 10/834,300

(22) Filed: Apr. 28, 2004

Related U.S. Application Data
(60) Provisional application No. 60/465,460, filed on Apr. 28, 2003.

(51) Int. Cl. F21V 9/16; G04B 19/06; G04B 19/04

(52) U.S. Cl. 368/228

(57) ABSTRACT

A watch, instrument panel and the like includes a face with a UV-reactive jewel and, optionally, other indicia. A UV-LED is provided in the watch or is directed at the instrument to illuminate the jewel. The jewel then disperses the radiation from the UV-LED toward the other indicia.

### RELATED APPLICATIONS

This application claims priority to provisional application Ser. No. 60/465,460 filed Apr. 28, 2003; incorporated herein by reference.

The subject matter of this application is also related to application Ser. No. 10/609,196 filed Jun. 28, 2003, entitled “Illumination Devices Using LEDs” and Ser. No. 10/139,660 filed May 3, 2002, entitled “Improvements in Illumination Devices for Watches and other Instruments”, incorporated herein by reference, now

### BACKGROUND OF THE INVENTION

A. Field of the Invention

This invention relates generally to an improvement in illumination devices such as a wristwatch or clock, indicator gauges, which may comprise a meter panel, directional gauges, used for example in motor vehicles, illumination accessories which can be used inside a passenger vehicle, commercial or industrial fixtures, and signage all of which utilize UV-LED's.

B. Description of the Prior Art

In my U.S. Patent Pending application Ser. No. 10/139,660, incorporated herein by reference and also in my U.S. Patent Pending application Ser. No. 10/609,196, I have described various applications using UV-LED's.

### OBJECTIVES AND SUMMARY OF THE INVENTION

It is an objective of the present invention to extend the above-mentioned uses of UV-LED's and provides a new and improved system through which sufficient illumination or radiation can be provided to both indicia of interest as well as images and other decorative elements.

It is another objective of the present invention to provide an improved illumination device used as an accessory in passenger vehicles for viewing treated devices in low light or in the dark,

Another objective of the invention is to provide illumination from above, the sides or underneath a fixture or furniture, for consumer or commercial use,

A further objective of the invention is to provide illumination for commercial or consumer usage such as exit or directional signs.

The present invention seeks to attain these objectives by disposing a light emitting element, on, inside, underneath or in close proximity of the center, sides, above or behind in an orderly, systematic or random placement and rendered light emissive or is activated by means of an electronic circuit which is installed within or in close proximity of said article.

More particularly, the light source is disposed either on an inner surface, imbedded, behind or above, in a manner that is aesthetic but functional and the radiation of treated indicia is virtually invisible to the viewer.

In many instances various objects must be observable in low light or in the dark. In instances where it is not possible, or it is inconvenient to provide full illumination, low level lighting is provided to illuminate the observed object either directly, laterally, using edge-effect type lighting or using backlight type illumination (wherein the light source is built into or disposed behind the object to be observed). However, these solutions have been found to be unsatisfactory because of a poor contrast ratio, glare or mediocre lighting at best. Moreover, in many instances these types of devices are not visually efficient or esthetically pleasing.

For example, most automobiles use some form of interior illumination for visibility at night or low light conditions. Some automobile manufactures such as BMW use what is called, theatre lighting, which keeps a very low visible light inside the automobile at all times.

Another example where improved illumination would be useful is in movie theatres where the, exit signs are visible during the movie. The glare or color distortion can be greatly improved.

One effective means of lighting objects comprise so-called black lights. This type of lighting is particularly desirable for providing illumination in low lighting conditions and is especially useful when used in combination with phosphorescent or fluorescent inks, or objects having fluorescent colors applied on the object being illuminated. It is also important to note that there are over 460 minerals and gemstones that fluoresce in a bright, colorful and sometimes spectacular manner.

The UV light source could be made to provide a broad radial pattern over the entire area or modified with a directional cone or shield focusing the light to the desired area for illumination.

### BRIEF DESCRIPTION OF THE DRAWINGS

The invention will be better understood by reference to the following description, taken in connection with the appended drawings, in which like reference numerals indicate like parts, and in which;

FIG. 1A. shows a top view of a wristwatch;

FIG. 1B-1I. show side views of a wristwatch in accordance with this invention;

FIG. 2A-2B. shows the top and side view of an instrument panel, respectively;

FIG. 3A-3J. shows the close-up and side views of a wristwatch;

FIG. 4A-4B. shows the side views of a wristwatch;

FIG. 5A-5G. shows accessories applicable for vehicles;

FIG. 6A-6J. shows furniture and fixtures in accordance with this invention;

FIG. 7A-7N. shows signage variations in accordance with this invention.

### DETAILED DESCRIPTION OF THE DRAWINGS

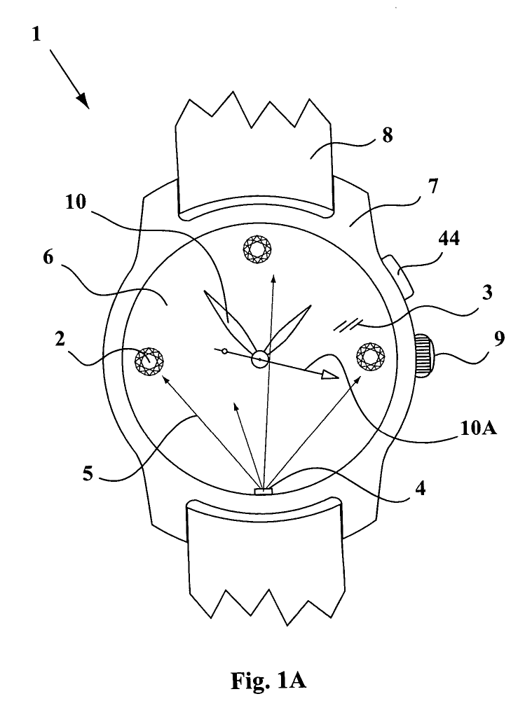

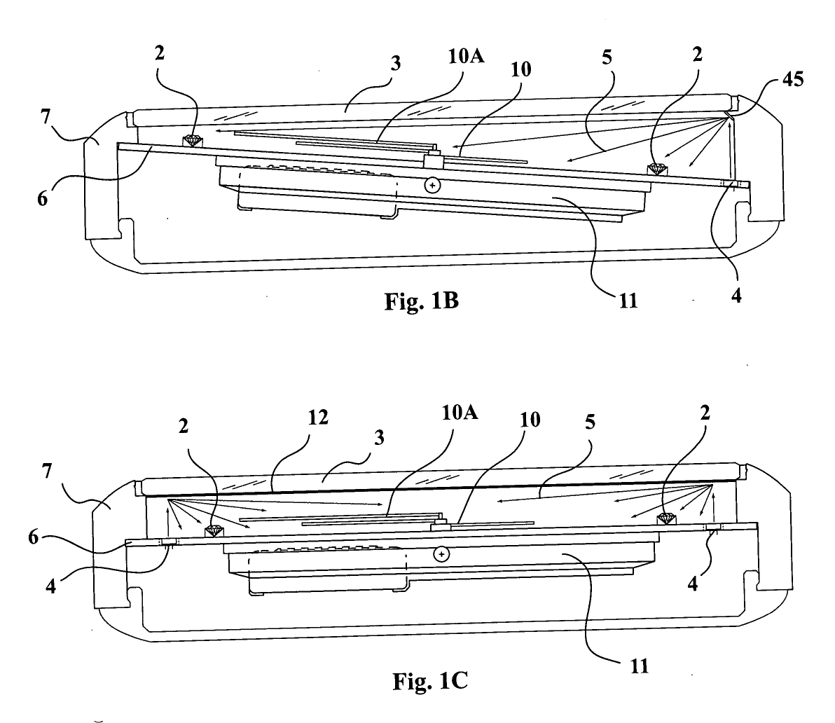

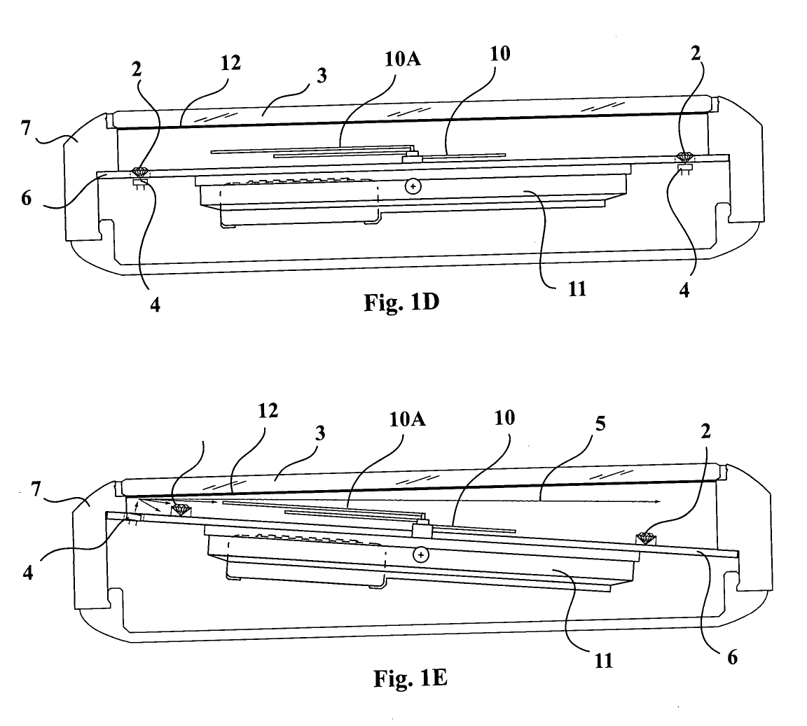

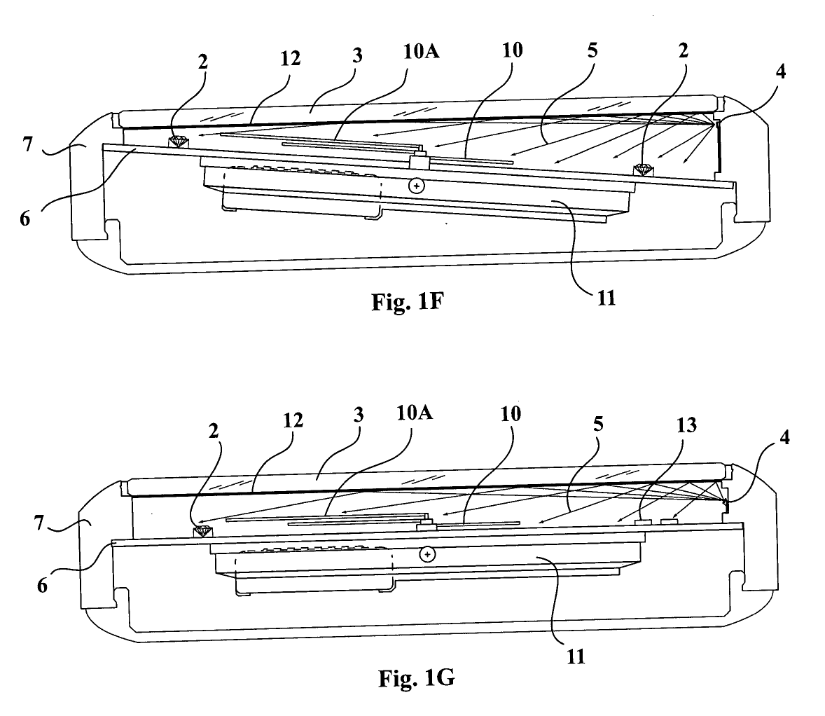

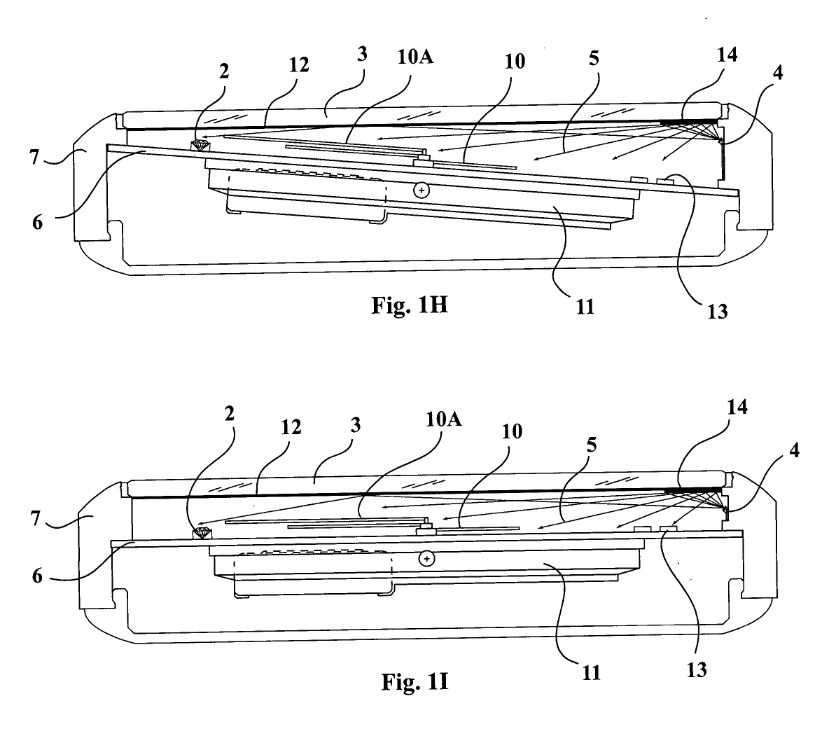

Referring now to FIG. 1A, a top view of a wristwatch 1 is shown with a rounded case 7 and a crystal 3. Hour and minute hands 10 and 10A display the time and are connected to a watch movement 11. The watch face 6 could be angled or parallel with the watch case 7. Appropriate minerals or gems 2 are provided on the watch face 6. The minerals or gems function as the absorbers of the ultraviolet light.

A radiation emitting device 4, preferably a UV-LED, which may be in the form of a packageless, lensless, a raw dice, a chip, surface mounted ceramic, tin can package, or a UV resistant package. The device 4 is mounted in a cavity or aesthetically positioned on the outer perimeter of the watch case interior. Wires or contacts (not shown) of the device 4 along the outer perimeter down to the undersurface of the watch face 6 and make contact with the connectors of a circuit board (not shown), and is used to mount a control mechanism for controlling the operation of the device 4 which is activated by a pusher 44 button for UV illumination.

Referring now to FIGS. 1B through 11, shows the profile view of a wristwatch with a rounded case 7 and a crystal 3. Hour 10 and minute 10A hands display the time and are connected to a watch movement 11. The watch face 6 could be angled or parallel with the watch case 7. Minerals or gems 2 are on the surface of the watch face with an LED radiation source, preferably a UV-LED 4 mounted underneath the watch face and pointed upward towards a reflective surface 45 which served as a reflector radiating beams 5 to the surface and intersecting the minerals or gems 2. The watch face 6 could also be made of a mineral reactive material such as mother-of-pearl which fluoresces under UV radiation.

Another embodiment of the invention in FIG. 1C, is a radiation device, preferably a UV-LED 4, and positioned on the outer perimeters located from underneath the watch face 6 pointed upwards toward a UV resistant layering 12 which reflects the rays 5 back to the surface where UV reactive minerals and gems 2 are excited and fluoresce.

FIG. 1D shows minerals or gems which are mounted on the watch face 6 but have an opening in said watch face from underneath the surface of which a radiation source, preferably a UV-LED 4 is located which is positioned to shine upward through the minerals or gems 4. The minerals or gems would absorb the radiation and would become excited and would fluoresce.

FIG. 1E shows another embodiment of the invention in which a radiation device 4 is located at the top of an angled watch face 6 and is angled to reflect from the UV resistant crystal 12 which reflects the radiation 5 back towards the surface.

FIGS. 1F and 1G shows a radiation source, preferably a UV-LED 4 positioned on the outer perimeter and angled towards a UV resistant and transparent crystal 3 which reflects the radiation 5 back towards the watch face 6, which has treated fluorescent indicia 13 or reactive minerals or gems 2.

FIGS. 1H and 1I shows a radiation source, preferably a UV-LED 4 positioned on the outer perimeter and angled to radiate towards a treated UV reflective crystal 3. The crystal 3 has an opaque reflective surface 14 which could be in the shape of an image, logo or design but prevents reflection 5 towards the viewer.

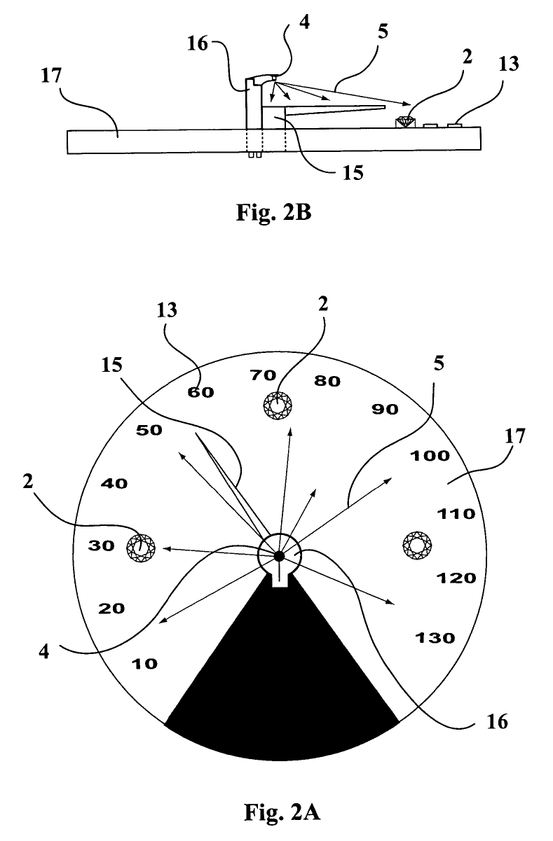

FIGS. 2A and 2B shows a top view and side view of an automotive speedometer with a dial face 17, speedometer needle 15, indicia 13 with a radiation source, preferably a UV-LED 4 which may be lensless to provide a wide beam, centrally located and positioned on the top of a cantilever device 16 radiating 5 downwards towards the surface. The dial face 17 could be made of a UV reactive mineral such as mother-of-pearl and have minerals or gems 2 mounted on the surface which would react to the radiation provided by the UV-LED 4. The contact points (not shown) would be connected underneath the surface providing an electrical source that when activated will activate the UV-LED 4 which radiates the surface and causes the minerals or gems to fluoresce.

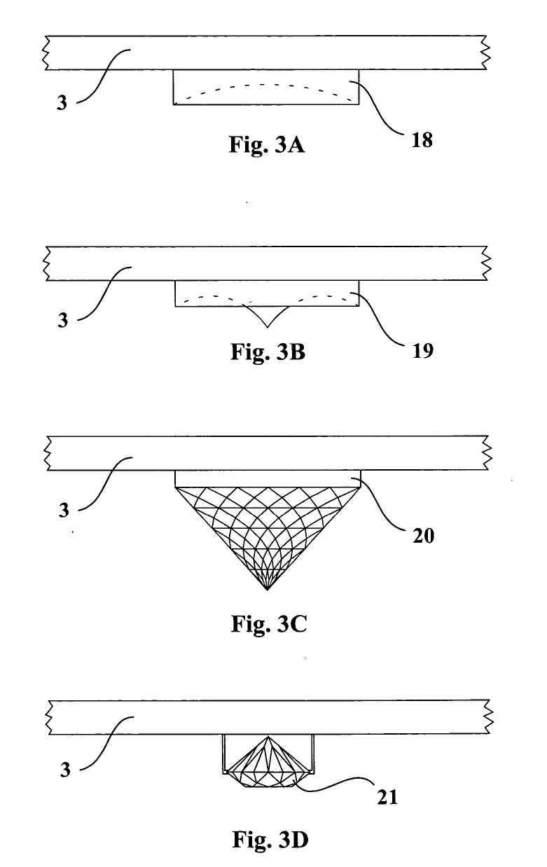

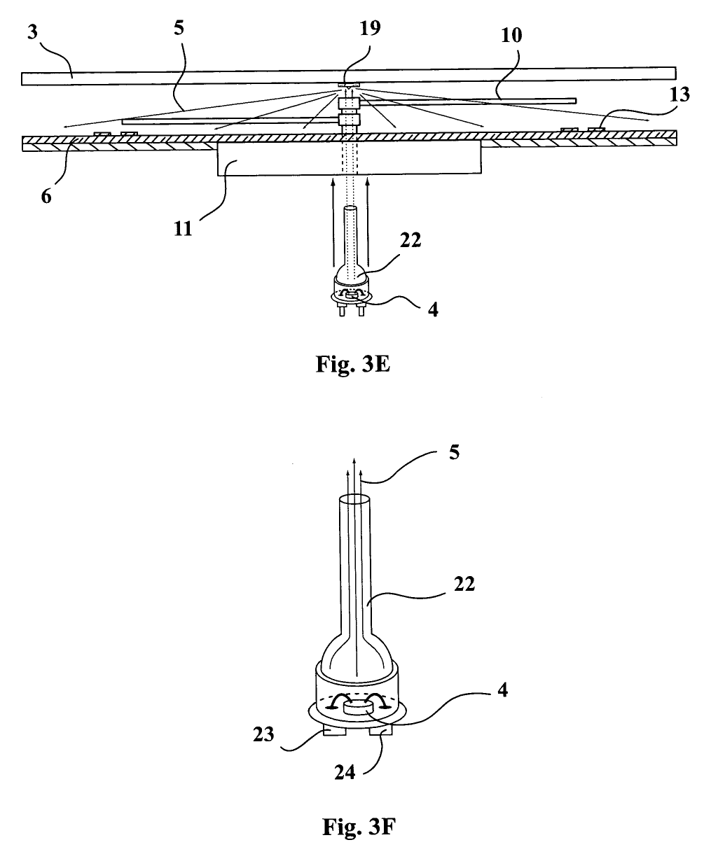

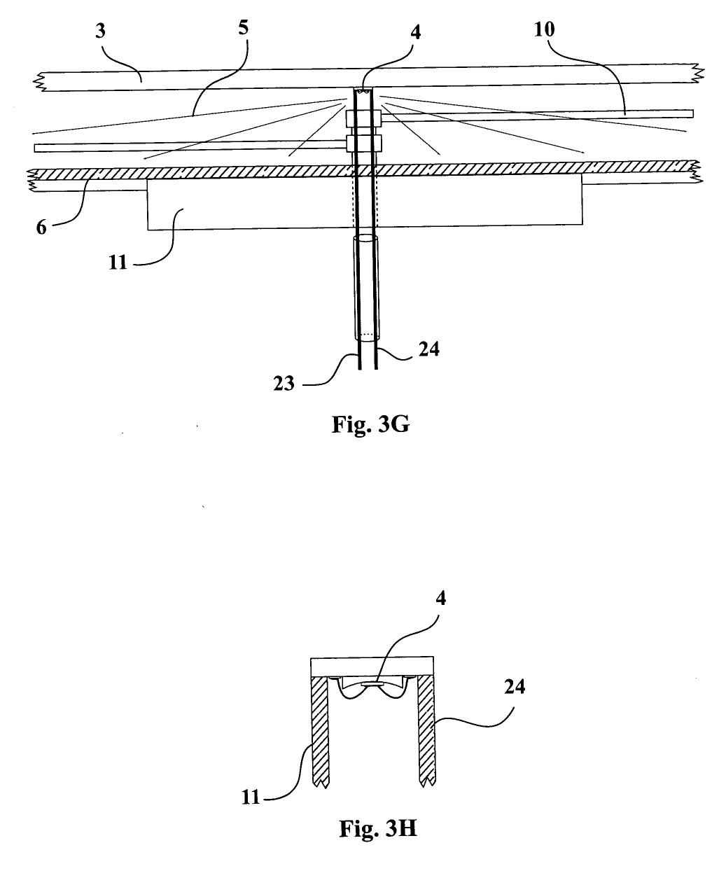

FIGS. 3A, 3B, 3C, and 3D show reflective devices which can collimate, split, and redirect or reflect radiation which is located underneath a clear or translucent substrate, preferably a watch crystal 3. These reflective devices can be designed to be an inverted oval 18, pointed with a curved outer perimeter 19 to redirect the radiation, a faceted gem 20 or a mineral or gem 21 with the main objective to direct radiation to the surface of instrumentation such as a watch or automotive instrument.

FIGS. 3E and 3F shows a profile of a watch with a center aperture in the movement 11 with a radiation emitting device, preferably a UV-LED 4 with an optical grade fiber-optic collimating device 22 to direct radiation 5 from underneath the surface upwards to the watch crystal 3 of which a reflective device 19 is positioned that reflects the radiation 5 downward to the watch face 6. The watch face 6 can be treated with fluorescent indicia 13 that fluoresce when activated by UV light.

FIGS. 3G and 3H shows a profile of a watch with a center aperture with an electromagnetic device preferably a lensless UV-LED 4, attached to the surface of a clear or translucent substrate 3. The UV-LED 4 is mounted and has electrical connections 23, 24 which lead from the illuminating source through the watch movements 11 center aperture underneath the surface and connected to a power source (not shown). When activated the UV-LED 4 radiates downward towards the surface of the watch or gauge.

FIGS. 31 and 3J shows a profile of a watch with a round watchcase 7, a crystal 3, watch face 6 with indicia 13, watch hands 10, watch movement 11 with a center aperture and a radiation emitting device 4 preferably a UV-LED. A UV-LED 4 is positioned underneath the watch movement 11 and could utilize a packageless, a focal lens or a lensless device, directing radiation through said center aperture upwards to a reflective cone 19 located on the undersurface of the watch crystal 3. The radiation is reflected downwards towards the surface, which is treated with phosphor or fluorescent indicia. The radiation would cause the phosphor or fluorescent indicia to become excited and fluoresce.

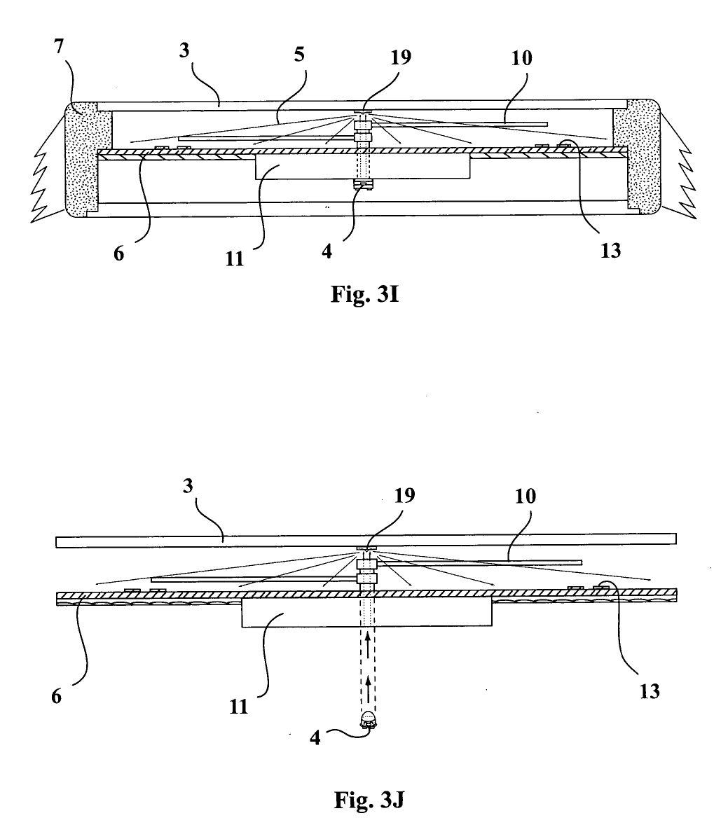

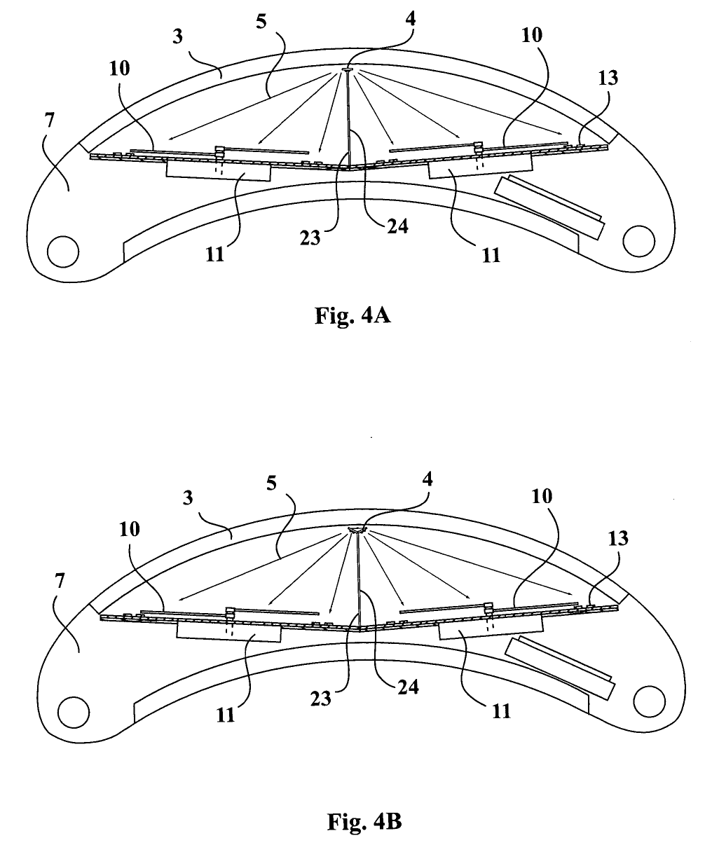

FIGS. 4A and 4B shows a profile of a watch with a watchcase 7, a crystal 3, indicia 13 with two watch movements 11, on an angled watch face, with at least one radiation emitting device 4 preferably a UV-LED. The UV-LED 4 has contacts 23, 24 which lead from the surface to underneath the surface connecting to a circuit board and power source (not shown). When activated the UV-LED radiates 5 downward towards the surface exciting the phosphor or fluorescent indicia 13.

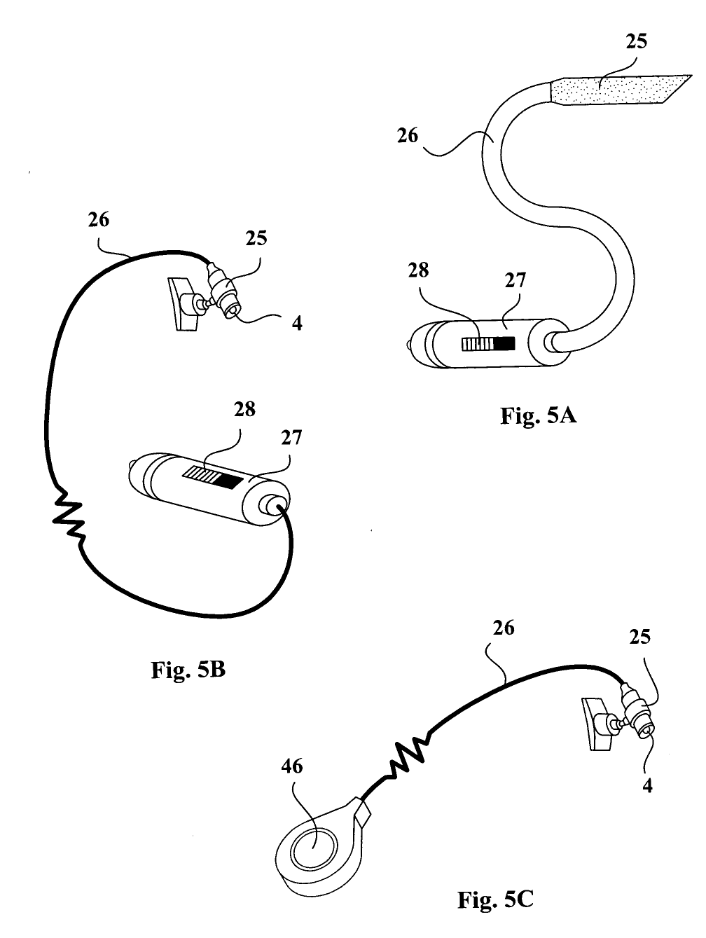

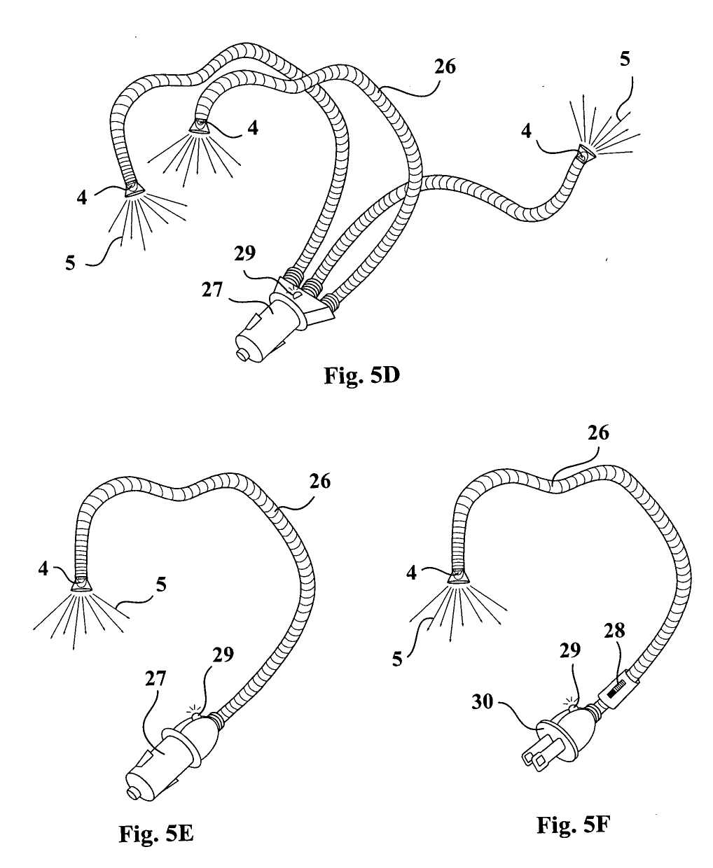

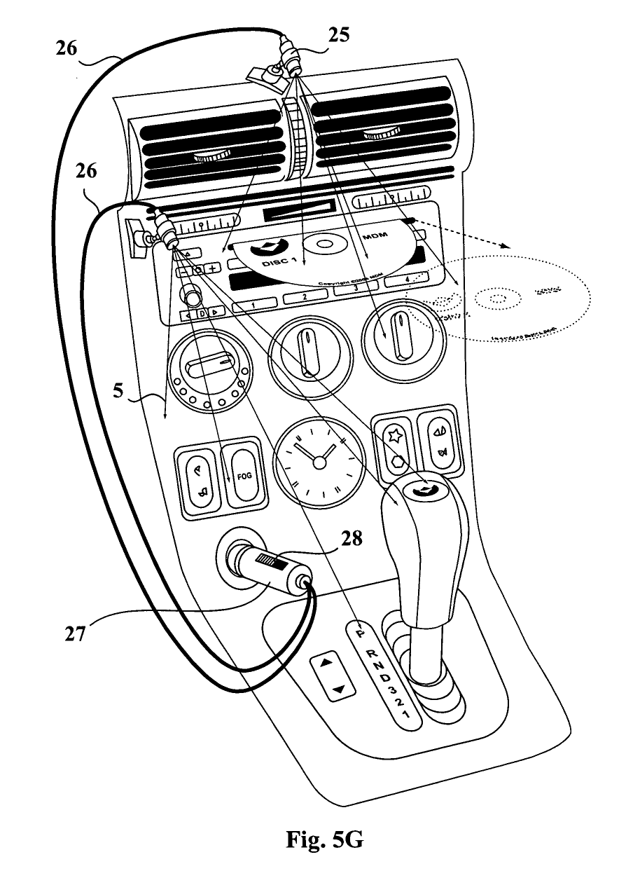

FIGS. 5A, 5B, 5C, 5D, 5E, 5F, 5G shows a flexible or goose-neck lighting device with a cigarette lighter or electrical plug adapter. This device with at least one radiation emitting device 4 preferably a UV-LED, a flexible connecting cable 26, a housing reflector 25, a cigarette 27 or electrical adapter 30 or a separate battery powered source 46 with an on/off switch 28, an indicator LED 29 and used inside a commercial vehicle. In FIG. 5G the flexible lighting device is shown inside of an automotive vehicle. When the lighting device is activated and releases radiation any phosphor or fluorescent treated indicia will become excited and fluoresce allowing easy viewing in low light or in the dark.

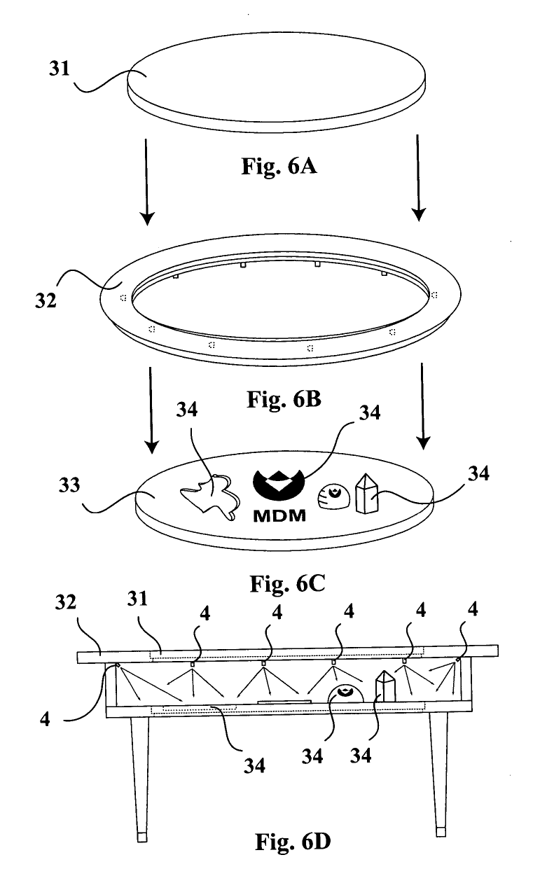

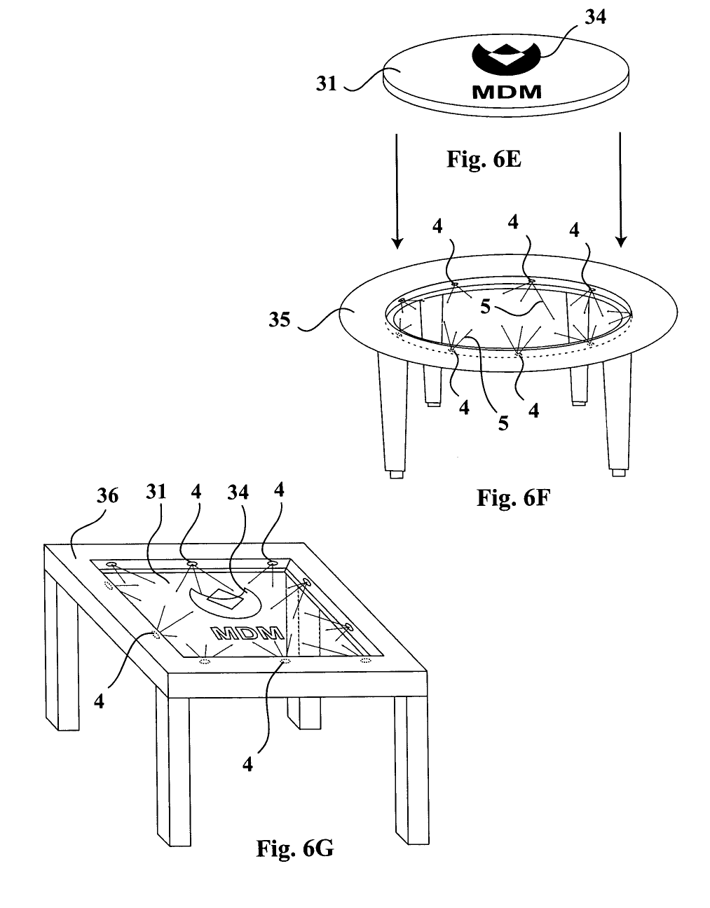

FIGS. 6A, 6B, 6C, 6D, 6E, 6F, 6G, 6H, 61, 6J shows tables or boxes for consumer or commercial display utilizing at least one radiation emitting device 4, preferably a UV-LED with treated fluorescent or phosphor indicia 34. FIG. 6A shows a clear or translucent substrate 31 that fits into the surface of a support apparatus 32 for framing with a secondary layer 33 which is supported by indicia 34 in the shape of images, logos or designs in single, two or three dimensions. The indicia 34 can be treated with phosphor or fluorescent inks so they will become excited and fluoresce when radiated by at least one UV-LED 4. FIGS. 6E and 6F shows a table with a clear or translucent substrate 31 with a phosphor or fluorescent indicia 34 on the underside of the surface which is placed into table with a flange 35. There is at least one radiation source, preferably a UV-LED 4 positioned on the outer perimeter inside the rim and flush with the side so the clear or translucent substrate 31 fits without obstruction. The UV-LED 4 has contacts leading to a power source (not shown) such as an electrical outlet. When activated the UV-LED shines through the glass sides directed to the phosphor or fluorescent treated indicia enabling it to fluoresce. FIG. 6G provides the same overall effect as FIGS. 6E and 6F except that the clear or translucent substrate 31 is set into a cavity in the table top 36 with a flange so that the recessed UV-LEDs 4 are above the substrate 31 radiating downward onto the phosphor or fluorescent treated indicia 34. FIG. 6H shows a display box 37 with a frame 38 with at least one UV-LED 4 and a radial pattern shining inward so that the interior or added indicia that are treated with phosphor or fluorescent will become excited and fluoresce. FIG. 61 and FIG. 6J are variants with at least one UV-LED 4 positioned to radiate from above, the sides or underneath.

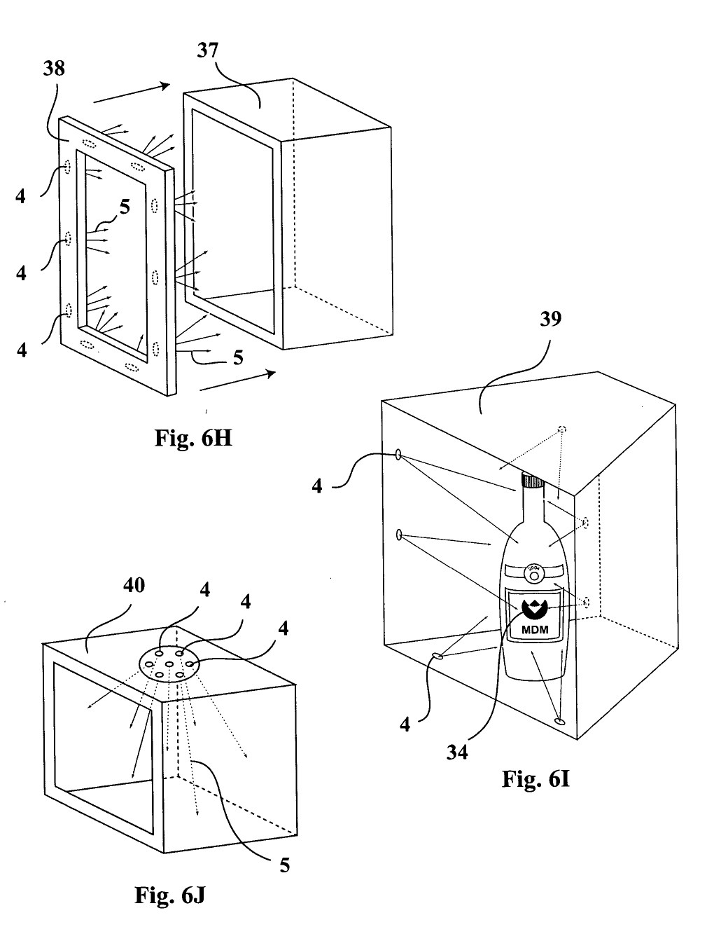

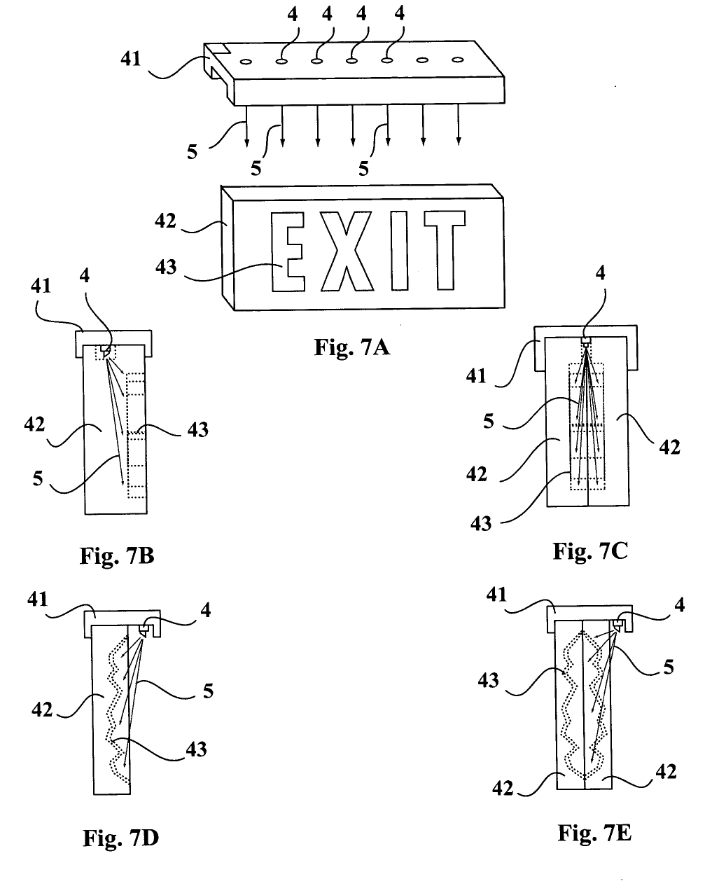

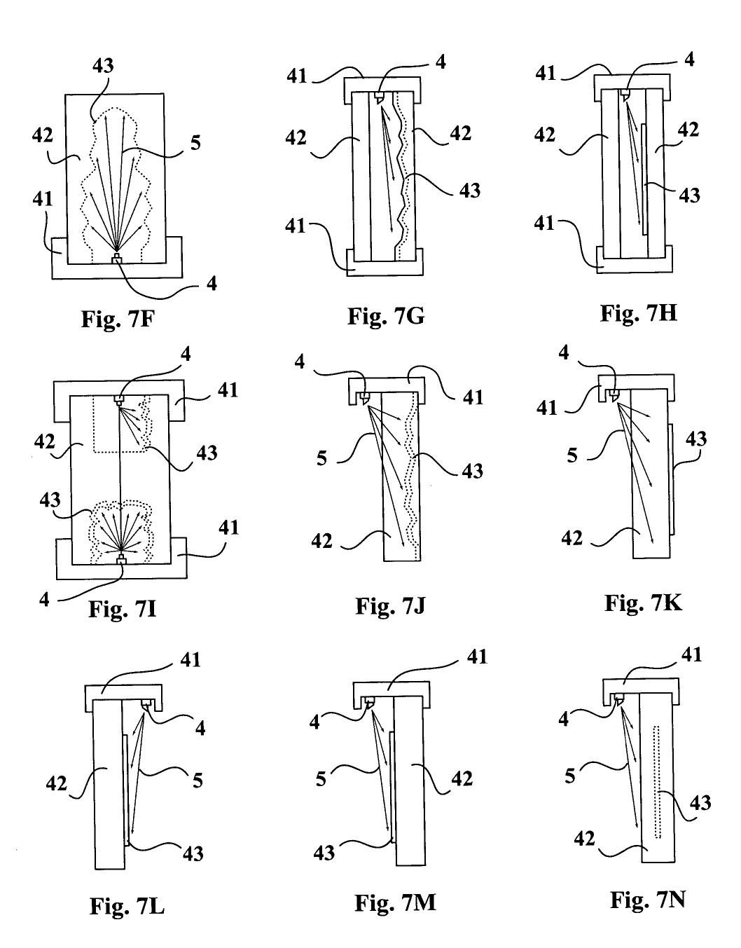

FIG. 7A shows a front view of a sign with a top framed structure 41 utilizes at least one radiation emitting device, preferably a UV-LED 4 shining downward 5, inside of, in front of, or behind the clear or translucent substrate 43 of which the fluorescent or phosphor treated indicia in the shape of an image, design, logo or numbers will fluoresce, enabling viewing of signage in low light or in the dark. FIG. 7B is a variant side view of 7A but the UV-LED 4 is encapsulated inside the clear or translucent substrate 42 with the treated indicia 43. FIG. 7B another variant of 7A shows the side view of a UV-LED 4 positioned from behind with indicia 43 inside of the clear or translucent substrate 42. FIG. 7C shows the top frame 41 with the UV-LED 4 positioned in between two separate clear or translucent substrates 42 with treated indicia 43 creating another unusual effect. FIGS. 7D-7N shows different additional variants of the UV-LED 4 from the front, behind, above and under clear or opaque substrates which have indicia either inside or outside of the substrate.

The term ‘jewel’ is used herein generically to cover precious stones, semiprecious stones, gems, and mother-of-pearl and other minerals and materials that fluoresce or exhibit other lighting effects when exposed to UV light. Hundreds of mineral species are known to be capable of fluorescence For example: Corundum is on of the most important gem species. Two of it varieties—blue sapphire and ruby fluoresce from red to orange, diamonds usually fluoresce blue on the outer rim and yellow in the center. Other colors from minerals include blue fluorescence from benitoite, lemon yellow from autunite, magenta-pink from pectolite, and so on. These jewels are then placed as discussed above to obtain a highly desirable, esthetically pleasing effect. Moreover, while most jewels are fairly small, some of them do come in large sizes as well. For example, mother-of-pearl can be used as a sheet that covers most or the whole face of the watch.

While the invention has been described with reference to several particular embodiments, it is to be understood that these embodiments are merely illustrative of the principles of the invention. Accordingly, the embodiments described in particular should be considered as exemplary, not limiting, with respect to the following claims.

I claim:

1. A watch comprising:
a face with a plurality of indicia, including a jewel that reacts to UV light;
a light-transmissive cover disposed on over said face; and
a radiation source emitting UV light at said face, including said jewel.

2. The watch of claim 1 wherein said watch includes a case having a side wall and said radiation source is disposed at a corner between said side wall and said cover.

3. The watch of claim 1 wherein said face is angled with respect to said cover.

4. The watch of claim 1 wherein said watch includes a case having a side wall and said radiation source is disposed adjacent to said side wall.

5. A watch comprising:
a face with indicia;
a light transmissive cover disposed over said face;
a jewel affixed at said face;
a radiation source emitting UV light at said jewel to be radiated toward the face.

6. The watch of claim 5 wherein said radiation source is disposed underneath said face.

7. An instrument panel comprising:
a face with a plurality of indicia, including a jewel that reacts to UV light;
a light-transmissive cover disposed on over said face; and
a radiation source emitting UV light at said face, including said jewel.

8. An automotive instrument panel comprising:
a plurality of indicia made of a material that reacts to UV light; and
a flexible UV light radiation source including a first end providing power and a second end with UV-LED arranged to direct light at said indicia.

9. The panel of claim 8 wherein said first end is adapted to be inserted into a cigarette lighter.

10. The panel of claim 8 wherein said flexible UV light radiation source includes several flexible arms, each terminating in a separate UV-LED.

11. A display case comprising:
a housing holding an article and having an opening, said article having an indicia reactive to UV light; and
a frame surrounding said opening and including a UV-LED directed at said article.

12. A sign comprising:
a base with an indicia including one of a graphic and an alphanumeric element, said indicia being reactive to UV light; and
a frame surrounding said opening and including a UV-LED directed at said indicia.
